(19) United States
(12) Patent Application Publication
(10) Pub. No.: US 2017/0213137 A1
(43) Pub. Date: Jul. 27, 2017

(54) SYSTEMS AND METHODS FOR PREDICTING CURRENT AND POTENTIAL RANGES OF VEHICLES BASED ON LEARNED DRIVER BEHAVIOR

(71) Applicant: Toyota Motor Engineering & Manufacturing North America, Inc., Erlanger, KY (US)

(72) Inventor: Benjamin M. Geller, Hermosa Beach, CA (US)

(21) Appl. No.: 15/006,007

(22) Filed: Jan. 25, 2016

(51) Int. Cl. G06N 5/04; G01C 21/34

(52) U.S. Cl. CPC G06N 5/04; G01C 21/3484

(57) ABSTRACT

A system for determining current and potential ranges of a vehicle includes a sensor that is used to detect energy data corresponding to an amount of energy remaining in the vehicle, such as fuel in a gasoline engine or fuel cell or a state of charge (SOC) of a battery. The system also includes a processor that can determine a current range of the vehicle in at least one direction based on a current status of the vehicle and the remaining energy levels. The processor can also determine a potential range of the vehicle that can be achieved if at least one user-controllable factor is changed from the current status of the vehicle. The system also includes an output device for outputting the current range of the vehicle and the potential range of the vehicle. The system may show fuel and/or recharging stations within the current and potential ranges.

### BACKGROUND

Field

The present disclosure relates to navigation systems operating in conjunction with vehicles, and more particularly relates to systems and methods for determining a current and a potential range of vehicles based on current and historical data.

Description of the Related Art

Many consumers are interested in the efficiency of their vehicles as greater efficiency reduces operating costs. Thus, range prediction systems have been implemented in vehicles for some time. These conventional range prediction systems typically include a sensor for detecting a current fuel level of the vehicle and include the capability to measure distances travelled by the vehicle. The range prediction systems use this information to predict a range of the vehicle based on the current fuel level. Conventional range prediction systems first predict the fuel efficiency of the vehicle (i.e., in miles per gallon (mpg)) by dividing a distance that is traveled over a period of time to the amount of fuel that is used by the vehicle to travel the distance. The systems then calculate a range of the vehicle by multiplying the calculated fuel efficiency with the remaining amount of fuel. Similar systems are used to determine energy efficiency of electric vehicles except SOC, or some measure related to SOC, is used in place of fuel levels.

Actual ranges that vehicles can travel are dependent upon many factors beyond calculated fuel efficiency and remaining fuel levels. For example, a vehicle can expend more energy when driving on a city road than on a highway, or can expend more energy when traveling uphill than downhill. Thus, ranges predicted by conventional range prediction systems are often inaccurate.

Many of the factors that affect actual vehicle ranges are controllable by the driver. For example, an aggressive driver who prefers high rates of acceleration can have a shorter range than a conservative driver who prefers lower rates of acceleration. Also, a driver who prefers to set a vehicle to a sports mode can have a shorter range than a driver who prefers an economy mode. Also, a driver who prefers to have an air conditioning system turned on high can have a shorter range than a driver who prefers to drive with the air conditioning turned off.

Thus, systems and methods for predicting current and potential ranges of vehicles based on learned driver behavior would be beneficial.

### SUMMARY

Described herein is a system for determining current and potential ranges of a vehicle. The system includes a sensor that is used to detect energy data that corresponds to an amount of energy remaining in the vehicle, such as a remaining SOC of a battery or amount of fuel in a fuel tank. The system also includes a processor that can determine a current range of the vehicle in at least one direction based on a current status of the vehicle and the amount of remaining energy. The processor can also determine a potential range of the vehicle that can be achieved if at least one user-controllable factor is changed from the current status of the vehicle. The system also includes an output device for outputting the current range of the vehicle and the potential range of the vehicle.

Also described is a system for determining a range of a vehicle. The system includes an energy sensor configured to detect energy data corresponding to an amount of energy stored in the vehicle. The system also includes an efficiency sensor configured to detect efficiency data corresponding to current energy efficiency of the vehicle. The system also includes a memory configured to store a driver history including driver efficiency data corresponding to at least one user-controllable factor. The system also includes an input/output port configured to receive efficiency data corresponding to an environment of the vehicle. The system also includes a processor coupled to the energy sensor, the efficiency sensor, the memory and the input/output port and configured to predict a current range of the vehicle based on the amount of energy stored in the vehicle, the detected efficiency data, the driver efficiency data and the received efficiency data.

Also described is a method for determining current and potential ranges of a vehicle. The method includes detecting, by a sensor, a stored amount of energy remaining in the vehicle. The method also includes determining, by a processor, a current range of the vehicle in at least one direction based on a current status of the vehicle. The method also includes determining, by the processor, a potential range of the vehicle that can be achieved if at least one user-controllable factor is changed. The method also includes outputting, by an output device, the current range of the vehicle and the potential range of the vehicle.

### BRIEF DESCRIPTION OF THE DRAWINGS

The features, obstacles, and advantages of the present invention will become more apparent from the detailed description set forth below when taken in conjunction with the drawings, wherein:

FIG. 1 is a drawing of an integrated navigation system within a vehicle according to an embodiment of the present invention;

FIG. 2 is a drawing of a third-party navigation system in communication with a vehicle according to an embodiment of the present invention;

FIG. 3 is a block diagram of the vehicle of FIG. 1 having components for determining a current range of the vehicle based on a current status of the vehicle and a potential range of the vehicle if one or more user-controllable factor is changed according to an embodiment of the present invention;

FIG. 4 is a flowchart illustrating a method for determining vehicle ranges including a current range of a vehicle and a potential range of the vehicle based on received data, stored data and detected data according to an embodiment of the present invention;

FIG. 5 is a flowchart illustrating a method for outputting one or more points of interest within a current range of a vehicle and a potential range of the vehicle based on received data, stored data and detected data according to an embodiment of the present invention;

FIG. 6 illustrates an exemplary output showing a current range of the vehicle of FIG. 1 and a potential range of the vehicle along with points of interest within the current range and the potential range using a method similar to the method of FIG. 4 or the method of FIG. 5 according to an embodiment of the present invention;

FIG. 7 illustrates an exemplary database showing stored data and detected data corresponding to the exemplary output of FIG. 6 according to an embodiment of the present invention; and

FIG. 8 illustrates an exemplary output showing a current range of the vehicle of FIG. 1 and a potential range of the vehicle, using a different output format and different efficiency data than in FIG. 6, along with points of interest within the current range and the potential range using a method similar to the method of FIG. 4 or the method of FIG. 5 according to an embodiment of the present invention.

### DETAILED DESCRIPTION

The systems and methods described herein provide several benefits and advantages over conventional range prediction systems. For example, the systems provide the benefit and advantage of predicting vehicle ranges based on previously-detected driver behavior. This provides the benefit and advantage of range predictions having a relatively high accuracy as well as the benefit and advantage that the accuracy of range prediction continuously increases as more driver behavior is detected and stored. The systems provide additional benefits and advantages such as the ability to predict a potential vehicle range that can be achieved if a user-controllable factor, such as a mode of the vehicle or a driving behavior, is different from a current status of the factor. This provides benefits and advantages such as encouraging drivers to drive more efficiently in order to achieve the potential range along with the benefit and advantage of informing drivers of particular locations or points of interest that can be reached with a current energy level of the vehicle if the driver changes the user-controllable factor.

An exemplary system includes an energy storage device such as a battery or a fuel tank and a sensor for detecting data corresponding to a current level of energy stored in the energy storage device. The system also includes an efficiency sensor for detecting data corresponding to energy efficiency of the vehicle and a memory for storing the detected energy efficiency data. The system can also include an input port for receiving energy efficiency data from a remote system or device. The system also includes a processor that can receive the detected level of energy, the detected energy efficiency data and the stored energy efficiency data and that can update the stored energy efficiency data using the currently detected energy efficiency data. The processor can also predict both a current range of the vehicle and a predicted range of the vehicle using the detected, received and stored energy efficiency data along with the detected amount of remaining energy.

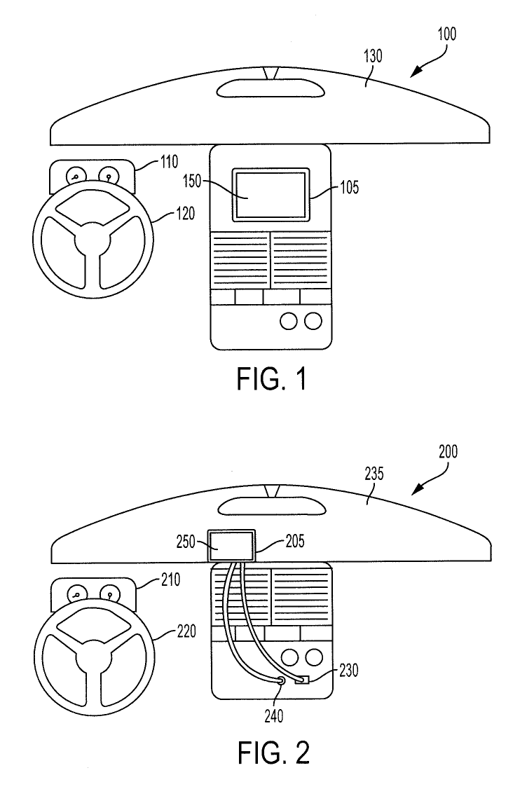

Turning to FIG. 1, an integrated navigation system within a vehicle is shown. Here, an interior of a vehicle 100 is depicted to include an integrated navigation unit 105 having a display portion 150 located at a central console area adjacent to the instrumentation gauges 110 and the steering wheel 120 and beneath the windshield 130. The navigation unit 105 may be controlled by a driver by using any of a plurality of input systems. For example, the navigation unit 105 may have a touch screen for accepting user input by way of tactile contact or a microphone for accepting user input by way of verbal commands.

The integrated navigation unit 105 may also be coupled to or in communication with components (not shown) of the vehicle 100 and thereby able to obtain information related to the status of the vehicle 100, including an amount of stored energy (e.g., remaining gallons of gas or remaining state of charge (SOC) of a battery, etc.), current and/or historical acceleration data of the vehicle 100, current and/or historical brake force data of the vehicle 100 or the like. In some embodiments, the navigation unit 105 may further process the information to display or audibly output derivative information to the user. For example, the navigation unit 105 may calculate a range of the vehicle 100 in one or more directions based on the remaining energy and this information. After calculating the range, the navigation unit 105 may display and/or audibly provide this information to the driver.

Turning now to FIG. 2, an interior of a vehicle 200 without an integrated navigation unit 105 is shown. Here, the navigation unit 205 may be a third-party device attachable (such as via a suction plate) to a vehicle windshield 235. As shown, the navigation unit 205 may include a display 250 and may draw power from a power source 240 found in the vehicle and/or may include a battery for energy storage. Further, the navigation unit 205 may be connected to a port 230 in communication with components of the vehicle 200. The port 230 may include any wired or wireless port such as a universal serial bus (USB) port, an Ethernet port, a Bluetooth port, a Wi-Fi port or the like.

In a similar manner as the navigation unit 105 of FIG. 1, the navigation unit 205 may be controlled by a driver by using any of a plurality of input systems. For example, the navigation unit 205 may have a touch screen for accepting user input by way of tactile contact, a microphone for accepting user input by way of verbal commands or may receive input data from an input device of the vehicle 200 via the port 230. The navigation unit 205 may be coupled to or in communication with one or more ECUs of the vehicle 200 and thereby able to obtain information related to the status of the vehicle 200 via the port 230, including the remaining energy of the vehicle 200 (such as remaining gallons of gas or remaining SOC, etc.), current and/or historical acceleration data of the vehicle 100, current and/or historical braking data of the vehicle 100 or the like. In a similar manner as the navigation system 105 of FIG. 1, the navigation unit 205 may calculate a range of the vehicle 200 in one or more directions based on the current fuel level along with other data.

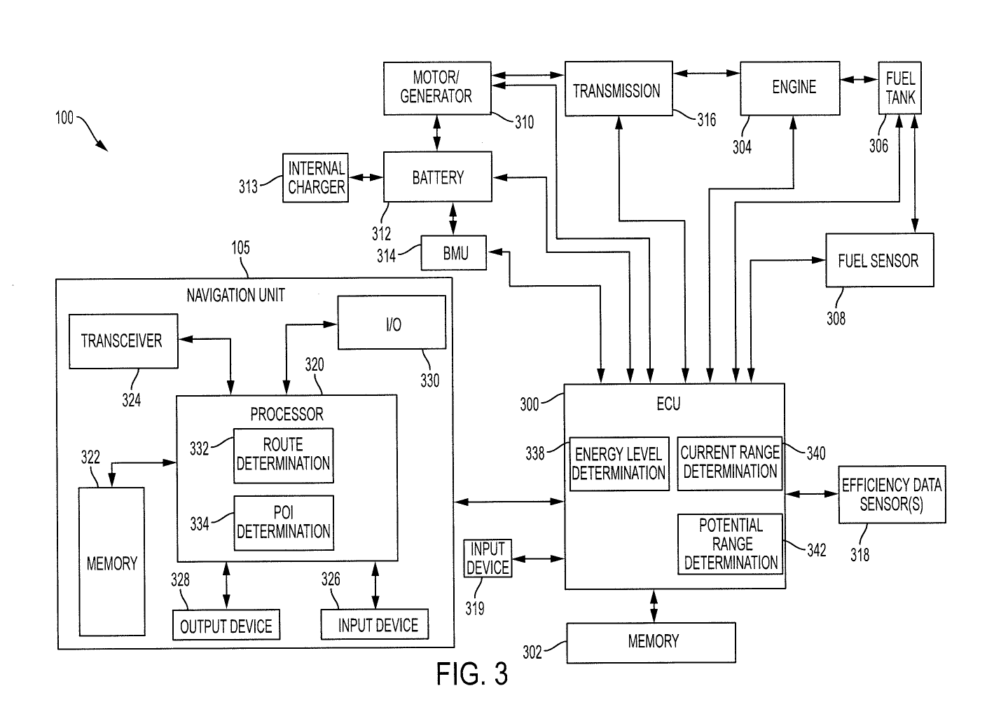

Turning now to FIG. 3, the vehicle 100 can include the navigation unit 105, an ECU 300, a memory 302, an engine 304, a motor/generator 310 and a transmission 316. The vehicle 100 can also include a fuel tank 306, a fuel sensor 308, a battery 312, an internal charger 313, a battery management unit (BMU) 314, one or more efficiency data sensors 318 and an input device 319. The groupings of components in the vehicle 100 and/or in the navigation unit 105 are exemplary only and one skilled in the art will realize that the components of the vehicle 100 can be grouped in various manners without departing from the scope of the disclosure. For example, the navigation unit 105 can be a separate navigation unit such as the navigation unit 205 of FIG. 2, a route determination unit 332 of a processor 320 of the vehicle can be implemented in the ECU 300, the input device 326 of the navigation unit 105 can instead be a vehicle input device or the like.

The navigation unit 105 can include the processor 320, a memory 322, a transceiver 324 (such as a global positioning system (GPS) device), an input device 326, an output device 328 and an input/output (I/O) port 330.

The input device 326 can include any input device such as a keyboard, a touchscreen, a microphone, a trackpad or the like. The output device 328 can include any output device such as a display, a touchscreen, a microphone or the like.

The transceiver 324 is capable of receiving signals and determining location data corresponding to a current location of the navigation unit 105 based on the received signals.

The I/O port 330 can include any input and/or output port capable of sending and/or receiving data. For example, the I/O port can include a USB port, a Bluetooth port, an Ethernet port, a CAN BUS port, a Wi-Fi port, a Bluetooth port, a 3G or 4G wireless port or the like. The I/O port 330 can communicate with one or more external systems to receive data corresponding to an environment of the vehicle 100 such as points of interest, current traffic conditions, speed limits of roads, directions between two points or the like.

The processor 320 can include one or more processors capable of implementing logic such as an ARM processor, a DSP processor, an ASIC, a FPGA, a distributed processor or other form of processor or controller. The processor 320 can include one or more physical and/or logical units for performing logic. For example, the processor 320 can include a route determination unit 332. The route determination unit 332 can receive a desired destination from the input device 326 and can determine one or more routes to the destination based on the current location of the vehicle 100.

The processor 320 can also include a point of interest (POI) determination unit 334. The POI determination unit 334 can determine one or more points of interest in a particular area, such as within a predetermined proximity of the vehicle 100. For example, the POI determination unit 334 can receive a request to determine the location of gas stations within 5 miles of the vehicle 100. The POI determination unit 334 can access the memory 322 and/or access a remote database via the I/O port 330 and search for the location of gas stations within 5 miles of the current location of the vehicle 100.

The memory 322 may include one or any combination of the following: a RAM or other volatile or nonvolatile memory, a non-transitory memory or a data storage device, such as a hard disk drive, a solid state disk drive, a hybrid disk drive or other appropriate data storage. The memory 322 may further store machine-readable instructions, which may be executed by the processor 320. The memory 322 may also or instead store data such as databases such as a database of points of interest within a particular area or location or a database of data corresponding to driver history.

The engine 304 is connected to the fuel tank 306 and can ignite a mixture of fuel and air, resulting in combustion that is converted to torque to drive one or more axles (not shown) via the transmission 316. The fuel tank 306 stores fuel, which may be regarded as chemical energy as it will be combusted by the engine 304. Thus, the fuel tank 306 may be referred to as an energy storage device. The fuel sensor 308 is coupled to the fuel tank 306 and detects data corresponding to an amount of fuel remaining in the fuel tank 306.

The motor/generator 310 can include one or more electric motors for converting electrical energy into torque and/or one or more generators for generating electrical energy from torque. The torque generated by the motor/generator 310 can be applied to the axle (not shown) via the transmission 316. Thus, the transmission 316 can apply torque to the axle from one or both of the engine 304 and the motor/generator 310.

The battery 312 can include any battery or other electrical energy storage device (such as a supercapacitor). In that regard, the battery 312 stores electrical energy usable by the motor/generator. The internal charger 313 is coupled to the battery 312 and can be coupled to and receive power from an external power source for charging the battery 312.

The BMU 314 is used to monitor various parameters or states of the battery 312 such as voltage, current, temperature and SOC of the battery 312. The functions and operations of the BMU 145 can be implemented using software, hardware and combinations thereof.

Although the vehicle 100 includes a motor/generator and an engine, one skilled in the art will realize that a vehicle according to the present disclosure can include any power source or any hybrid combination of power sources, such as a fuel cell, a combination of a fuel cell and a motor/generator, only an engine or the like.

The input device 319 can include any input device such as a touchscreen, a keyboard, a microphone, a track pad or the like. The input device 319 can receive user input and transmit the user input to the ECU 300 and/or the navigation unit 105. For example, the input device 319 can receive a selection by the user for the vehicle 100 to operate in a particular mode, such as an economy mode (ECO mode), a normal mode or a sports mode. In some embodiments, the input device 319 can be used in place of the input device 326 of the navigation unit 105.

The efficiency data sensors 318 can include one or more sensors capable of detecting data that can affect energy efficiency of the vehicle. For example, the efficiency data sensors can include an altimeter for detecting an altitude of the vehicle 100, a gradient sensor for detecting a gradient of a road, a camera for detecting traffic or other road conditions, an accelerometer for detecting an acceleration of the vehicle 100, a brake sensor for detecting an amount of braking of the vehicle 100, a speedometer for detecting a speed of the vehicle 100, etc. The efficiency data sensors 318 include additional or alternative sensors for detecting other data such as efficiency of the motor/generator 310, efficiency of the engine 304, torque losses of the transmission 316 or the like. In some embodiments, the efficiency data sensors 318 may not include actual sensors but may transmit information regarding settings of the vehicle 100 to the ECU 300. For example, the efficiency data sensors 318 may transmit a driving mode of the vehicle 100 to the ECU 300, a setting of an air conditioner or the like.

The ECU 300 may be electrically coupled to some or all of the components of the vehicle 100. The ECU 300 can include one or more processors or controllers specifically designed for automotive systems, and the functions of the ECU 300 can be implemented in a single ECU or in multiple ECUs. The ECU 300 can receive data from one or more components and control the operation of one or more components based on the received or determined data. In some embodiments, some or all of the functions of the processor 320 may be performed by the ECU 300.

The ECU 300 may include various physical and/or logical units for performing functions. For example, the ECU 300 can include an energy level determination unit 338 capable of determining how much energy is remaining (i.e., the fuel level and/or the SOC) based on data from the fuel sensor 308 and/or the BMU 314. The ECU 300 can also include a current range determination unit 340 capable of predicting a range of the vehicle 100 based on efficiency data.

The efficiency data can include received or stored environmental factors such as speed limits, altitude, grade, traffic or the like received from the navigation unit 105 and/or the efficiency data sensors 318. The efficiency data can also include detected factors such as remaining fuel/SOC or current speed of the vehicle and can include user-controllable factors (such as a current or stored detected acceleration or brake force) in order to more accurately predict the fuel range of the vehicle 100 over time.

The ECU 300 may also include a potential range determination unit 342 capable of predicting a range of the vehicle if one or more user-controllable factors were changed such as a range if a lower rate of acceleration is used, a range if an air conditioning system is turned off, a range if the vehicle is switched from a normal mode to an ECO mode or the like.

Each unit of the ECU 300 may be implemented in one or more separate ECUs or may be combined into one or more ECUs. Furthermore, the functions of the units may be implemented using software, hardware and combinations thereof. Additionally, some or all of the functions of the ECU 300 may be performed by the processor 320 and/or some or all of the functions of the processor 320 can be performed by the ECU 300.

The memory 302 may include one or any combination of the following: a RAM or other volatile or nonvolatile memory, a non-transitory memory or a data storage device, such as a hard disk drive, a solid state disk drive, a hybrid disk drive or other appropriate data storage. The memory 302 may further store machine-readable instructions which may be executed by the ECU 300. The memory 302 may also or instead store data such as databases, for example, a database of driver history such as acceleration, braking force or the like. In some embodiments, a single memory may be used in place of the memory 322 and the memory 302 or any data may be stored in one or both of the memories 322, 302.

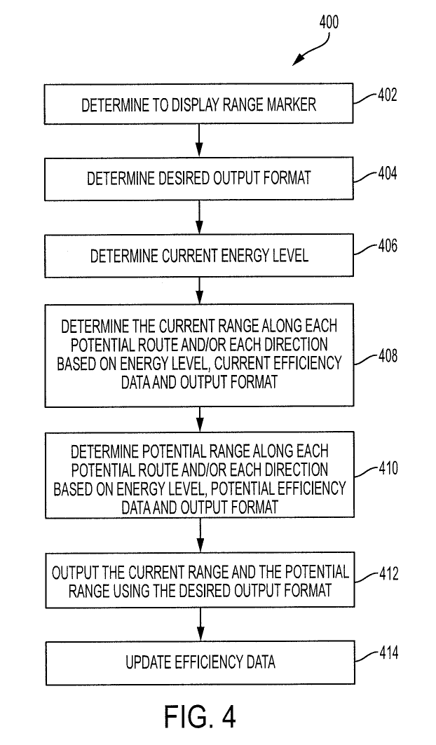

Turning now to FIG. 4, a method 400 for determining a current range of a vehicle, such as the vehicle 100, begins at block 402 where a processor (such as the ECU 300 and/or the processor 320) of the vehicle determines to output a current range of the vehicle and/or a potential range of the vehicle. This may be determined based on input received from a driver of the vehicle. For example, the driver may realize that he is low on gas and/or SOC and would like an indication of how far the vehicle can travel without a fill-up/recharge, and request this indication via an input device. Likewise, a user may make a selection using the input device for an output device to always display the vehicle range.

In some embodiments, the processor of the vehicle may determine to display the range marker based on logic. For example, if a fuel level or SOC drops below a predetermined amount of fuel or SOC, the processor may automatically cause the range, along with gas/charging stations within the range, to be displayed.

In block 404, the processor may determine the desired output format. The processor may determine the output format based on input received from the input device, based on a previous selection, based on a factory default setting or the like. The output format can be based on various default settings and/or user selections. For example, the range can be output using a color or pattern overlaying roads on a map, such as blue coloring on roads to represent road portions that are in range and black coloring on roads to represent road portions that are not in range. Likewise, the range can be output using a line enclosing the area within the range, or shading or coloring of the area within the range.

Another setting that can affect the output format is whether only the current range of the vehicle, a potential range of the vehicle or both will be output. Current ranges and potential ranges will be further described below with reference to blocks 408 and 410.

At block 406, the processor may determine the remaining energy level of the vehicle (such as the current fuel level and/or the current SOC). For example, the processor may receive energy level data from at least one of the fuel sensor or the BMU constantly or periodically, and/or may receive this data in response to a query.

In some embodiments, the range may be determined based on the fuel level, the SOC or a combination. For example, in a vehicle having only an engine, the range will be determined based on the fuel level and not the SOC. In a hybrid vehicle, a total range of the vehicle will be based on the fuel level and the SOC. However, a driver may desire to reduce an amount of gasoline used and may thus request that the range of the vehicle be based solely on the remaining SOC. Some hybrid vehicles may be designed such that a predetermined amount of fuel or SOC is to be reserved. The processor may determine to provide the range based on the fuel level and the SOC of these vehicles when both are above a predetermined level. However, when one of the fuel level or the SOC drops below this level, the processor may base the range on the one of the fuel level or the SOC alone that is above the predetermined level. This reduces the likelihood of the vehicle becoming stranded in case a range is predicted to be greater or larger than the vehicle can accomplish.

At block 408, the processor may determine the current range of the vehicle. In some embodiments, the processor can determine each potential route that the vehicle can take from a current location and deteiiiiine the range of the vehicle for each of the potential routes. In some embodiments, the processor can determine the range of the vehicle based on more general characteristics of the environment than each potential route. In some embodiments, the processor can determine the range using a combination of the potential routes and general characteristics of the environment.

The current range of the vehicle may be determined based on current efficiency data that includes at least one of received efficiency data (such as traffic conditions), detected efficiency data (such as whether an air conditioning unit of the vehicle is running) or stored efficiency data corresponding to a driver history (such as previously detected acceleration data). The range is also determined based on the current location of the vehicle, the remaining energy level and the desired output format (as some data may not be determined by the processor for certain output formats).

In particular, the received efficiency data corresponds to an environment within a predetermined distance of the vehicle. The received efficiency data can include one or more of the following: road or road segment distances (i.e., the distance of one or more roads or segments of roads), direct distances (i.e., distances between points “as the crow flies”), changes in altitude, a gradient of a road or terrain, traffic conditions, speed limits or current weather conditions, among others. In some embodiments, some or all of the received efficiency data can be stored in a memory instead of received from an external system. This data may still be referred to as received efficiency data.

The detected data can include one or more of the following: current altitude, a gradient of a road, a current mode of the vehicle, a current setting of one or more accessories of the vehicle, traffic conditions, speed limits, a current speed of the vehicle, a current acceleration rate of the vehicle, a current braking force of the vehicle, an efficiency of the motor/generator, an efficiency of the engine, torque losses of the transmission or an oxygen content percentage of ambient air, among others. In some embodiments, the detected data can instead be stored or received. For example, the gradient of the road can be stored in the memory and/or received from an external system instead of detected by a sensor.

The stored driver history can include efficiency data corresponding to one or more user-controllable factor such as one or more of the following: a previously-detected speeds of the vehicle, a previously-detected acceleration rate of the vehicle, a previously-detected brake force used or the like. In some embodiments, the stored driver history can correspond to specific roads or portions of roads. For example, the previously-detected speeds can correspond to a particular segment of a road. In some embodiments, the stored driver history can correspond more generally to driver behavior. For example, the previously-detected acceleration rate can include general acceleration patterns of the driver such as a preferred rate of acceleration of about 10 mph/s, or the previously-detected speeds of the vehicle can correspond to a driver's pattern of driving 10 mph over any given speed limit.

Once the processor receives and/or retrieves the efficiency data to be used, the current location of the vehicle, the remaining energy and the output format, the processor may calculate the current range. For example, some or all of the efficiency data can be weighted by a particular amount. This weighting may change over time. For example, the driver history data may have a relatively low weighting when a driver first purchases a vehicle, but this weighting may increase as more data regarding the driver is collected.

In block 410, the processor determines the potential range along each potential route and/or in various directions based on potential efficiency data, the current location of the vehicle, the remaining energy and the output format. The potential efficiency data includes much of the same data as the current efficiency data, but also includes at least one user-controllable factor that is set to a different value than in the current efficiency data. For example, a vehicle may be set to a normal driving mode. The current efficiency data will predict the range based on the normal driving mode, while the potential efficiency data may predict the range based on the ECO driving mode.

The processor determines which user-controllable factor(s) will be fixed and which user-controllable factor(s) will be varied. This determination may be made based on user input. For example, the driver may wish to know of or be aware of the range of the vehicle if he turns off an air conditioning system. In that regard, the user may use the input to select for the potential range to be based on the air conditioning being turned off.

In some embodiments, the processor may select which user-controllable factor will be varied based on which potential change will most increase the driving range. For example, the processor may determine that switching the mode from normal to ECO will extend the range in at least one direction by 10 miles and that conservative driving (such as lower acceleration rates and less brake force) will extend the range in the at least one direction by 15 miles. The processor may then determine that the potential range will be based on conservative driving.

The determination of which factor will be varied may also be based on a factory setting, a previously selected setting or the like. For example, a vehicle manufacturer may preset the potential range to be based on conservative driving in order to encourage conservative driving by the driver.

In block 412, the processor may cause an output device to output the current range and the potential range using the desired format. In some embodiments, only the current range or the potential range will be output. However, when the potential range is output, the processor may also cause the output device to output which user-controllable factor is changed and to what it is changed. For example, the output data may indicate that the potential range is based on a conservative driving style.

In block 414, the processor may update a database in the memory with the currently or recently detected efficiency data. For example, the database may store an average acceleration of the vehicle over each traveled segment or an average brake force at each intersection. During or after traversing a segment, the processor may update the average acceleration or average brake force based on the currently or recently detected acceleration or brake force.

By updating the efficiency data, the processor can more accurately determine the range of the vehicle as it may learn information that is not otherwise available, such as a slope of a road or a driver's preferred rate of acceleration. Furthermore, the accuracy of the predicted ranges will continue to increase as the vehicle detects more and more efficiency data. In turn, the drivers can more accurately understand their driving range so that they can determine if destinations are within the vehicle's capability or if stops must be made. Stated differently, use of the method 400 provides improved range prediction as drivers will be able to use their vehicle to the fullest potential while gaining further confidence in use of the vehicle. For example, use of the method 400 may reduce range anxiety for drivers of plug-in hybrid vehicles, electric vehicles and/or fuel cell vehicles. The method 400 can be used in a vehicle having any one or more of an engine, a motor/generator, a fuel cell or any other power generator.

In some embodiments, the vehicle may be an autonomous vehicle. In that regard, the efficiency of the vehicle may still be based on one or more user-controllable setting. For example, the efficiency of an autonomous vehicle may be based on a mode of the vehicle, a route selection preference (such as whether the vehicle is to take the fastest route or the most energy efficient route) or the like.

Processors of these vehicles may be designed to instruct the output device to output potential ranges of the vehicle based on any combination of these user-controllable settings. In that regard, the user can make informed selections of the user-controllable settings based on knowledge of the various potential ranges. For example, an autonomous vehicle may be set to select routes based on time efficiency. The processor may instruct the output device to output the current range based on the time efficient route selection along with a potential range based on energy efficient route selection. After viewing the current range and the potential range, the user can make an informed decision regarding whether or not to change the route selection preference.

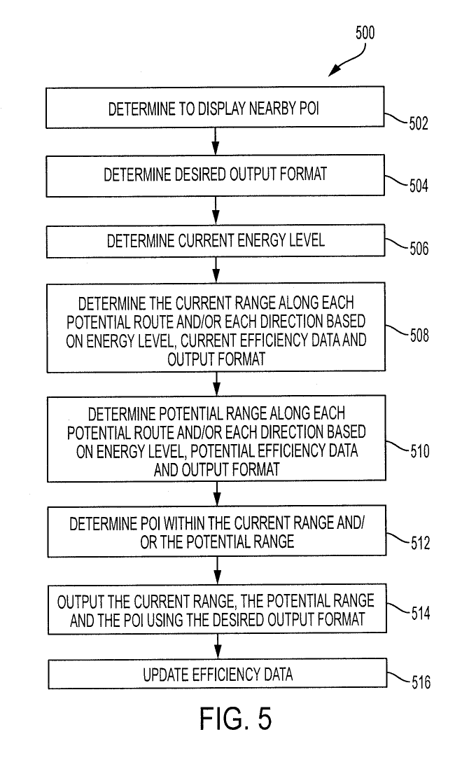

Turning now to FIG. 5, a method for displaying points of interest within at least one of a current range of a vehicle (such as the vehicle 100 of FIG. 1) or a potential range of the vehicle is shown. In block 502, a processor of the vehicle may determine to display one or more nearby points of interest. For example, a user may request, via an input device, to have all fueling stations or all electric vehicle charging stations be shown.

In some embodiments, the processor may determine to display the location of nearby points of interest based on logic. For example, once the remaining energy of the vehicle reaches below a predetermined level, the processor may determine to display all gas stations or charging stations within the current range of the vehicle and/or within the potential range of the vehicle. In some embodiments, the processor may cause points of interest outside of the current and potential range to be shown as well.

Blocks 504, 506, 508 and 510 perform similar functions as blocks 404, 406, 408 and 480 of FIG. 4.

In block 512, the processor may determine which, if any, of the particular points of interest are within the current range and/or within the potential range. For example, the processor may send location data corresponding to areas within the current and/or potential range to a remote system and receive the points of interest in return. In some embodiments, the processor may compare the current location and the range with data in a local memory to determine the points of interest within the range.

In some embodiments, the processor may determine that additional points of interest not specifically requested should be output. For example, if the vehicle is a plug-in hybrid vehicle and the driver requested the location of gas stations within the vehicle's range, the processor may determine that electric vehicle charging stations should be output if no gas stations are within the current or potential range.

In block 514, the processor may output the current range, the potential range and the points of interest using the desired output format. In some embodiments, only the points of interest within the current range are shown, in some embodiments only the points of interest within the potential range are shown and in some embodiments, points of interest within and outside of the current and/or potential range are shown.

In block 516, the processor may update the efficiency data in a similar manner as in block 416 of FIG. 4.

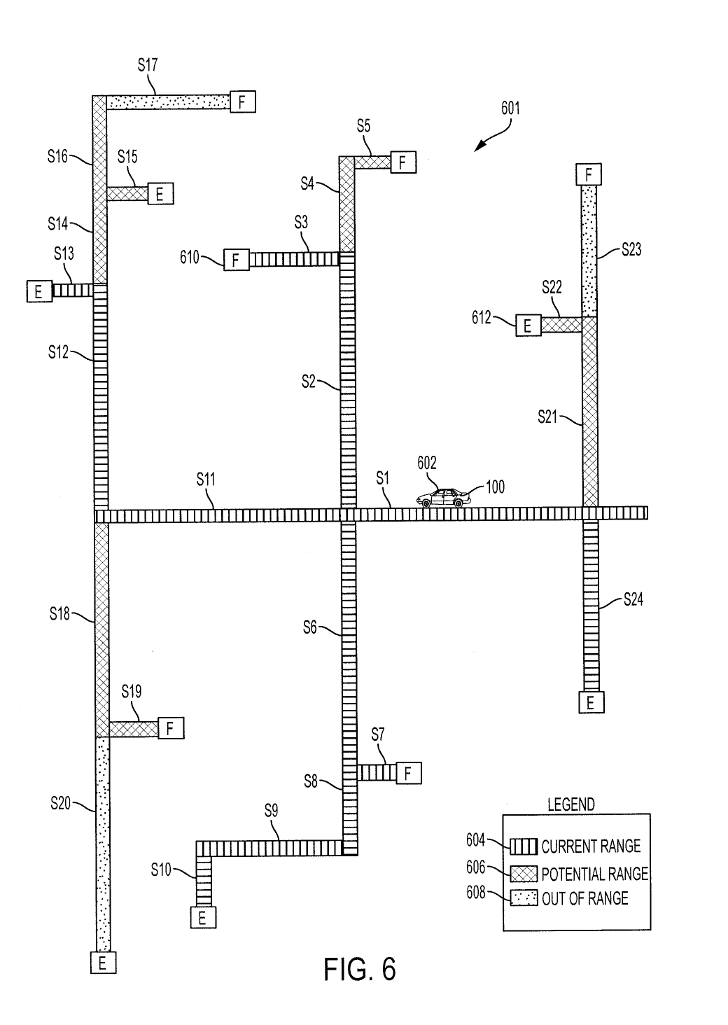

Turning to FIG. 6, an exemplary map 601 may be displayed by the output device 328 of the navigation unit 105 of FIG. 3. The roads of the map 601 have been divided into segments separated by intersections. One skilled in the art will realize that the segments may be selected based on any feature in addition to or instead of intersections such as distances, turns or the like, or that the range marker may be provided based on general data that does not include information corresponding to a specific segment or road.

A representation 602 of the vehicle 100 shows the position of the vehicle 100 relative to the various segments of the roads. The map 601 shows a current range marker 604, a potential range marker 606 and an out-of-range marker 608. Although the markers 604, 606, 608 are shown with cross-hatching overlaying the roads, the markers may also or instead include different coloring (such as blue for the current range, orange for the potential range and black for out of range). As shown, the current and potential ranges of the vehicle 100 are neither symmetrical nor circular about the location of the vehicle 100. This is due to the lack of symmetry of the environmental factors in various directions from the vehicle 100. The map 601 also locations of fueling stations 610 and electric vehicle charging stations 612.

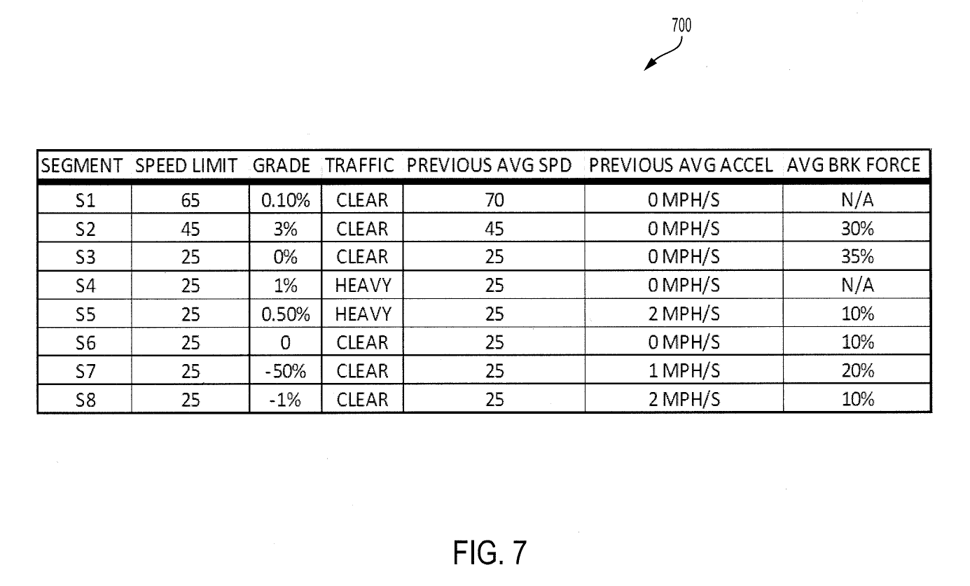

Referring now to FIGS. 6 and 7, a table 700 illustrates examples of efficiency data that may be stored in the memory 302 of FIG. 1. The exemplary efficiency factors include a speed limit for each segment, a grade of each segment, current traffic conditions for each segment, average speeds based on previously-detected speeds along each segment, average accelerations based on previously-detected accelerations along each segment and average braking forces based on previously-detected brake forces along each segment.

As shown, the current range marker 604 extends for a longer distance along segments S6, S8, S9 and S10 than along S2 and S3. This difference in the current range is based on the efficiency factors. For example, segment S2 has a large grade relative to any of segments S6, S8, S9 and S10. Thus, more fuel or electrical energy will be required for the vehicle to traverse segments S2 and S3 than segments S6, S8, S9 and S10.

The potential range marker 606 corresponds to a potential range of the vehicle if the vehicle is driven in a more conservative manner. By seeing how much further the vehicle 100 can go with more conservative driving, the driver may be incentivized to drive more conservatively. Also, if the driver wishes for the vehicle to reach a particular location that is slightly beyond the current range but within the potential range, the driver is aware of the fact that he can extend the range of the vehicle to reach the location without stopping for energy.

When determining the range of the vehicle, the processor may take the direction of travel into account. For example, the driver may have to travel to the next intersection prior to moving in a reverse direction. Thus, the processor may determine that the ranges to the rear of the vehicle will include the remainder of the current segment S1 in the current direction along with another trip of segment Si in the reverse direction. Thus, as shown, the range may be relatively shorter on roads behind the vehicle 100 than in front of the vehicle.

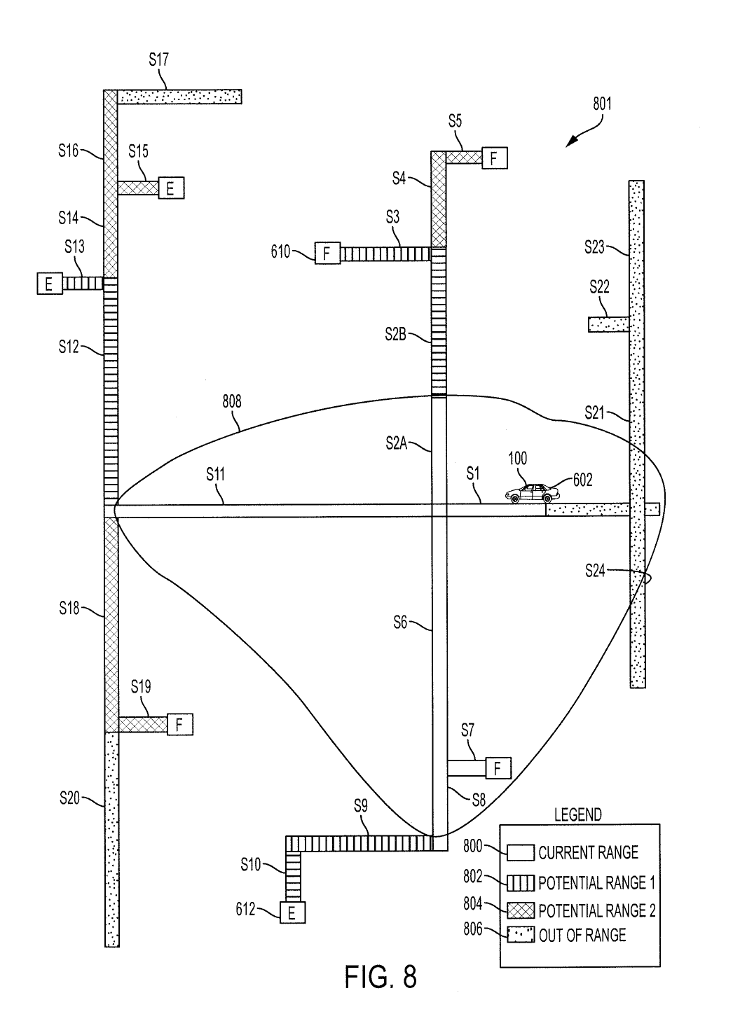

Turning now to FIG. 8, another map 801 of the same area as the map 601 of FIG. 6 is shown although with different efficiency factors at play and with different output selections. For example, the map 801 of FIG. 8 includes a range marker 808 showing the entire area within the current range. FIG. 8 also includes a current range marker 800, a first potential range marker 802, a second potential range marker 804 and an out of range marker 806 overlaid on the roads.

One of the selected options may be that only points of interest in the direction of travel of the vehicle 100 are shown. Thus, no points of interest behind the driver appear on the map 801. Similarly, another option may be that out of range points of interest not be shown. Thus, points of interest not within the second potential range marker 804 are not shown.

The vehicle 100 may presently be set to sports mode. The first potential range marker 802 corresponds to a potential range of the vehicle if the driver switches from the sports mode to a normal mode, and the second potential range marker 804 corresponds to a potential range of the vehicle if the driver switches from the sports mode to an ECO mode.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for determining current and potential ranges of a vehicle comprising:
a sensor configured to detect energy data corresponding to an amount of energy remaining in the vehicle;
a processor configured to determine a current range of the vehicle in at least one direction based on a current status of the vehicle and a potential range of the vehicle that can be achieved if at least one user-controllable factor is changed from the current status of the vehicle; and
an output device configured to output the current range of the vehicle and the potential range of the vehicle.

2. The system of claim 1 wherein the at least one user-controllable factor includes at least one of a driving mode of the vehicle, a setting of a component of the vehicle, a rate of acceleration or a brake force.

3. The system of claim 1 wherein the output device is configured to output the current range of the vehicle using a first color or a first pattern overlaying portions of roads within the current range and to output the potential range of the vehicle using a second color or second pattern overlaying portions of the roads within the potential range.

4. The system of claim 1 wherein the output device is configured to output the current range of the vehicle by at least one of using a first color or a first pattern to fill in an area of a map corresponding to the current range or outlining the area of the map corresponding to the current range using a first line, and to output the potential range of the vehicle by at least one of using a second color or a second pattern to fill in an area of the map corresponding to the potential range or outlining the area of the map corresponding to the potential range using a second line.

5. The system of claim 1 further comprising an efficiency sensor configured to detect efficiency data corresponding to energy efficiency of the vehicle and a memory configured to store the efficiency data and wherein the processor is further configured to determine the current range of the vehicle based on the stored efficiency data.

6. The system of claim 5 wherein the stored efficiency data includes at least one of a speed, a rate of acceleration or a brake force.

7. The system of claim 1 further comprising at least one of an engine, a fuel cell or a battery and wherein the stored amount of energy corresponds to at least one of an amount of fuel remaining in a tank to be used by the engine, an amount of fuel remaining in a tank to be used by the fuel cell or an SOC remaining in the battery.

8. A system for determining a range of a vehicle comprising:
an energy sensor configured to detect energy data corresponding to an amount of energy stored in the vehicle;
an efficiency sensor configured to detect efficiency data corresponding to current energy efficiency of the vehicle;
a memory configured to store a driver history including driver efficiency data corresponding to at least one user-controllable factor;
an input/output port configured to receive efficiency data corresponding to an environment of the vehicle; and
a processor coupled to the energy sensor, the efficiency sensor, the memory and the input/output port and configured to predict a current range of the vehicle based on the amount of energy stored in the vehicle, the detected efficiency data, the driver efficiency data and the received efficiency data.

9. The system of claim 8 wherein the processor is further configured to determine a potential range of the vehicle that can be achieved if one or more of the at least one user-controllable factor is changed.

10. The system of claim 8 wherein the at least one user-controllable factor includes at least one of a driving mode of the vehicle, a setting of a component of the vehicle, a rate of acceleration or a brake force.

11. The system of claim 8 further comprising an output device configured to output the current range of the vehicle using a first color or a first pattern overlaying portions of roads that are within the current range.

12. The system of claim 8 further comprising an output device configured to output the current range of the vehicle by at least one of using a first color or a first pattern to fill in an area of a map that is within the current range or outlining the area of the map that is within the current range.

13. The system of claim 8 further comprising an output device and wherein the processor is further configured to determine a location of at least one point of interest within the current range of the vehicle and the output device is configured to output the location of the at least one point of interest within the current range of the vehicle.

14. The system of claim 13 wherein the processor is configured to determine the location of the at least one point of interest when at least one of a fuel level of the vehicle or a state of charge (SOC) of the vehicle reaches or drops below a predetermined level.

15. A method for determining current and potential ranges of a vehicle comprising:
detecting, by a sensor, a stored amount of energy remaining in the vehicle;
determining, by a processor, a current range of the vehicle in at least one direction based on a current status of the vehicle;
determining, by the processor, a potential range of the vehicle that can be achieved if at least one user-controllable factor is changed; and
outputting, by an output device, the current range of the vehicle and the potential range of the vehicle.

16. The method of claim 15 further comprising:
determining, by the processor, at least one point of interest within the current range of the vehicle;
determining, by the processor, at least one point of interest within the potential range of the vehicle; and
outputting, by the output device, the at least one point of interest within the current range of the vehicle and the at least one point of interest within the potential range of the vehicle.

17. The method of claim 16 further comprising determining, by the processor, the at least one point of interest within the current range of the vehicle and the at least one point of interest within the potential range of the vehicle when at least one of a fuel level of the vehicle or a state of charge (SOC) of the vehicle reaches or drops below a predetermined fuel level or SOC.

18. The method of claim 15 further comprising detecting, by an efficiency sensor, efficiency data corresponding to energy efficiency of the vehicle and storing, in a memory, the efficiency data; and wherein determining the current range of the vehicle is further based on the stored efficiency data.

19. The method of claim 18 wherein the stored efficiency data includes at least one of a speed, an acceleration or a brake force.

20. The method of claim 15 further comprising detecting, by a GPS device, a current location of the vehicle and wherein determining the current range of the vehicle and the potential range of the vehicle are each further based on the current location of the vehicle.
